(19) United States
(12) Patent Application Publication
(10) Pub. No.: US 2026/0160915 A1
(43) Pub. Date: Jun. 11, 2026

(54) PRESSURE PULSE SIGNAL WAVELET FILTERING

(71) Applicant: Halliburton Energy Services, Inc., Houston, TX (US)

(72) Inventors: David Bennett, Houston, TX (US); Ning Tu, Singapore (SG); Senmao Tan, Singapore (SG); Yang Yu, Singapore (SG); Zhijie Sun, Houston, TX (US); Zheguang Zou, Singapore (SG)

(21) Appl. No.: 18/973,753

(22) Filed: Dec. 9, 2024

(51) Int. Cl. G01V 1/48; E21B 47/18

(52) U.S. Cl. CPC G01V 1/48; E21B 47/18; G01V 2210/23

(57) ABSTRACT

Techniques for filtering pressure pulse signals include receiving a pressure pulse signal, determining a wavelet filtering configuration, wherein the wavelet filtering configuration comprises at least one of number of levels or one or more coefficients, and generating a filtered pressure pulse signal based, at least in part, on the pressure pulse signal and a wavelet filter, wherein the wavelet filter is configured based the wavelet filtering configuration.

### BACKGROUND

Hydrocarbons and similar substances may exist in underground deposits and can be extracted by various means, such as drilling wells and using pumps to lift the substance to the surface. These hydrocarbons may then be transported to processing facilities via pipelines for transformation into commercial product and shipment. Tracking and measuring various aspects of the associated operations is important for maintaining and improving the operations. However, because many of the operations occur far beneath the surface of the earth, or extend for hundreds of miles, it can be difficult to determine the conditions that exist within the well, its surrounding formation(s) and supporting transport mechanisms.

### BRIEF DESCRIPTION OF THE DRAWINGS

Embodiments of the disclosure may be better understood by referencing the accompanying drawings.

FIG. 1 is a block diagram illustrating wavelet filtering for pressure pulse analysis, according to some implementations.

FIG. 2 depicts the result of applying a wavelet filter to a pressure pulse signal, according to some implementations.

FIG. 3 depicts example charts illustrating the application of wavelet filtering using a first set of coefficients to a first pressure pulse signal, according to some implementations.

FIG. 4 depicts example charts illustrating the application of wavelet filtering using a second set of coefficients to a second pressure pulse signal, according to some implementations.

FIG. 5 depicts example charts illustrating the application of wavelet filtering using a third set of coefficients to a third pressure pulse signal, according to some implementations.

FIG. 6 depicts a system for filtering noise from a pressure pulse signal using a wavelet filter, according to some implementations.

FIG. 7 is a flow diagram depicting operations for determining a wavelet filter configuration, according to some implementations.

FIG. 8 is a flow diagram depicting operations for filtering a pressure pulse signal using wavelet filtering, according to some implementations.

FIG. 9 is a flow diagram depicting operations for determining one or more conditions of a well, pipeline, or similar system using wavelet filtering, according to some implementations.

FIG. 10 is a diagrammatic illustration of an example well system, according to some implementations.

FIG. 11 is a block diagram depicting an example computing system, according to some implementations.

### DESCRIPTION

The description that follows includes example systems, methods, techniques, and program flows that embody aspects of the disclosure. However, it is understood that this disclosure may be practiced without these specific details. In some instances, well-known instruction instances, protocols, structures, and techniques have not been shown in detail in order not to obfuscate the description.

Because systems used to extract and transport substances (e.g., hydrocarbons) from subsurface formations are located underground or spread across a large distance, system conditions within the well system, transport pipelines, formation, etc. can be difficult to monitor. One technique that can be used to determine system conditions during system operation (e.g., drilling, extraction, transport, etc.) is pressure pulse analysis.

Pressure pulse analysis involves generating a pressure pulse within the well or pipeline system. The pressure pulse results in a pressure differential travelling throughout the system and reflecting back towards the source. The reflected pressure pulse is then measured and the resulting signal analyzed. Various system conditions can be detected based on their contribution to the resulting signal.

Well and pipeline system operations are frequently noisy and the resulting signal from a pressure pulse may include noise not caused by the pressure pulse. Thus, reducing the noise in the pressure pulse signal may be beneficial when analyzing the pressure pulse.

Wavelet filtering is a technique that can improve the result of pressure pulse analysis by filtering out short-time duration patterns created by active pumping and other activities. The use of wavelet filtering may improve results when identifying and quantifying blockages, depositions, leaks, traveling materials (e.g., PIGs, cementing plugs), performing various analyses (e.g., fracturing perforation and cluster analysis, cementing quality analysis, wellbore intervention analysis), etc.

A particular benefit attributable to wavelet filtering is accuracy. In particular, wavelet filtering, especially in systems with high degrees of pressure variation during operations, enables a higher level of refinement when analyzing raw, unprocessed data by facilitating the delineation of the pressure pulse signal vs. ongoing signals generated by activities such as pumping.

Threshold for use in the wavelet filtering can be based on noise variance from pumping activities and may be evaluated against raw data to determine appropriate fitment as part of wavelet filtering process. The thresholds can be expressed as a coefficient θⱼ, as defined in Equation 1.

$${θ}_{j} = {\tilde{σ}}_{j} \sqrt{2 log ( N )} \qquad Equation 1$$

$$where {\tilde{σ}}_{j} is the estimation of noise variance at level j and N is the length of the signal .$$

The appropriate wavelet coefficient, capturing unique data features while removing noise, is elected by comparing the raw and filtered signals using a bandpass, moving average, or other filters

According to some implementations, the general process for wavelet filtering begins by applying a wavelet transform (e.g., a discrete wavelet transform) to an input pressure pulse signal. The result of the wavelet transform is a set of wavelet coefficients at different levels. A threshold value, defined in Equation 1, is applied to each level to remove noise from the wavelet coefficients, preserving only the coefficients associated with the signal. An inverse wavelet transform is then applied to the thresholded wavelet coefficients to recover the pressure pulse signal. The wavelet-filtered pressure pulse signal consists of the input pressure pulse signal and the reflection of the pressure pulse, with noise filtered out by the wavelet filter. The wavelet transform output is then filtered using a wavelet filter. An inverse wavelet transform is then applied to the wavelet filter output resulting in the wavelet-filtered pressure pulse signal. The wavelet-filtered pressure pulse signal is the input pressure pulse signal without the noise filtered out by the wavelet filter.

As shown above, threshold coefficients at different levels (corresponding to different frequency ranges) can be calculated based, at least in part, on the noise variance at each level. Further, the number of levels used for the wavelet transform can be parameterized as well. If prior knowledge of the input pressure pulse signal is available (e.g., if the impact of the well system operating conditions on the input pressure pulse signal is already known), the number of levels used for the wavelet transform may be predetermined. In cases where there is no prior knowledge (or existing prior knowledge is not usable, unreliable, etc.), the number of levels may be based, at least in part, on the sampling frequency used for the input pressure pulse signal. Additional refinement to the number of levels may be made by considering the statistical properties of the residual noise.

As illustrated below, proper determination of the threshold coefficients and number of levels is important, as improper parameter selection may lead to over-filtering, resulting in a loss of distinguishing data and impacting analysis results.

In operation, a baseline system comprising a pre-pressure pulse benchmark may be generated. The baseline system may be generated by capturing a representative dataset prior to sending a pressure pulse. The representative dataset may include a baseline signal that includes operational pumping noise and other characteristics of particular system and its operations. A metric may be established based, at least in part, on pressure variation from the signal average of the baseline signal using techniques such as summation, sum or least squares, difference variation, comparison of raw data signals to filtered signals to determine a sum of differences, etc. The metric can be used to determine the appropriate coefficients for use in the wavelet transforms and wavelet filtering.

A pressure pulse may be generated in the well or pipeline system using a variety of means including, but not limited to, an inline valve closure, a suspension in pumping, injection of additional fluids or gas into the system, opening a diagnostic port and bleeding off fluids or gas, etc.

The resulting pressure differential waves may be sampled using a variety of mechanisms. For example, a transducer located within the system may transform the pressure pulse into electrical signals that are then sampled by a microprocessor or other device to generate a pressure pulse signal.

After the pressure pulse signal is generated, a post-pressure pulse signal may be generated. The post-pressure pulse signal serves a similar purpose to the baseline signal and includes the operational pumping noise and other characteristics of the particular system but captures these characteristics after the pressure pulse has been generated. Thus, the post-pressure pulse signal captures changes to the system resulting from the pressure pulse. The baseline signal can be compared to the post-pressure pulse signal to determine if the operating conditions of the system were changed due to the pressure pulse. The metric used to determine the appropriate coefficients for the wavelet transforms and wavelet filtering can be calculated for the post-pressure pulse signal and used to determine whether the pressure pulse has resulted in changes to the operational characteristics of the system.

In cases where the pressure pulse has resulted in changes to the operational characteristics of the system, the pressure pulse signal can be segmented accordingly and separate wavelet coefficients may be created and used for each segment.

Once analyzed (and segmented, if appropriate), the pressure pulse signal may continue to be analyzed to determine live object distance, deposition profile, etc. using other inversion techniques. Analysis of the pressure pulse signal may result in determining one or more conditions of the system.

The wavelet filtering techniques discussed herein can be combined with bandpass filtering, Fourier transforms, Butterworth filters, or similar techniques. For example, the impact that various operational characteristics of the system have on the pressure pulse signal may be known prior to the generation of the pressure pulse. For example, pump equipment may emit noise of a certain frequency, and a bandpass filter may be applied to exclude noise of the same frequency. These filtering techniques can thus be used to remove known levels of noise from the pressure pulse signal prior to determining the wavelet coefficients and performing the wavelet transform and filtering operations. Removal of the noise from known noise sources can improve the results of the wavelet filtering process.

In some implementations, a system operation or attribute in the wellbore or pipeline may be modified or updated based on a determination of one or more conditions of the system. For example, an operation (at the surface, downhole, within a pipeline, etc.) may be performed and/or directed to be performed to change a downhole operation or attribute based on whether one or more particular conditions are detected. For example, attributes of an actual drilling or extraction operation in the wellbore may be set based on whether one or more conditions exist, such as the presence of a leak, an incorrectly located plug, etc. Examples of such attributes of the drilling/extraction operation may include depth, composition of the proppant used for fracking, composition of the fracking fluid used for fracking, the pump rate for fluid, etc. For further example, attributes in a pipeline system may be determining the location of lost equipment such as PIGs, restrictions to flow such as depositions, or system leaks.

### Example Implementation

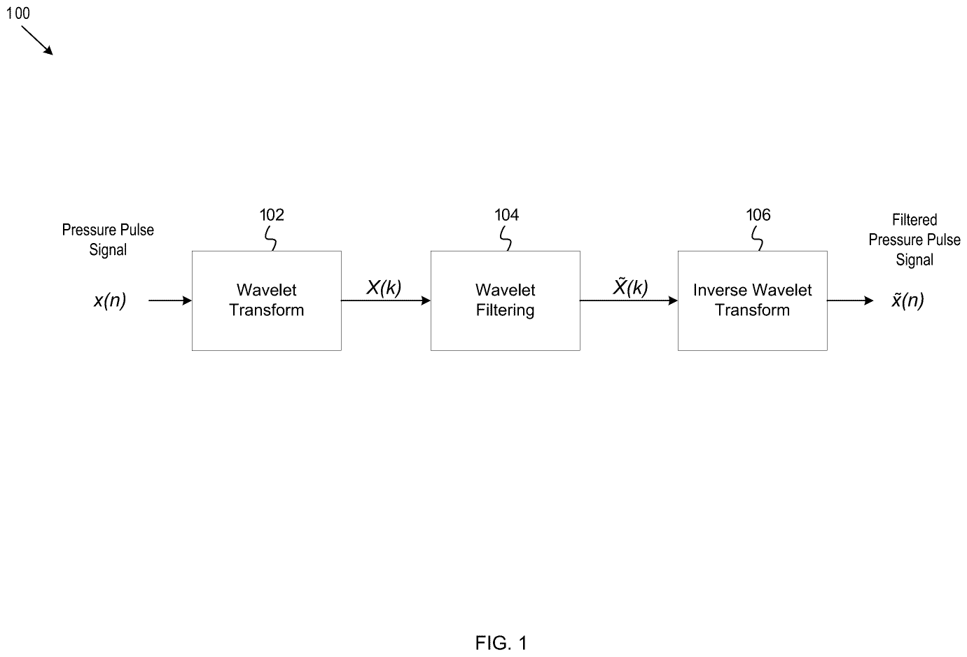

FIG. 1 is a block diagram illustrating wavelet filtering for pressure pulse analysis, according to some implementations. FIG. 1 depicts a block diagram 100, including a wavelet transform 102, a wavelet filter 104, and an inverse wavelet transform 106.

The wavelet transform 102 is applied to an input signal x(n) which, in this example, is a pressure pulse signal. The wavelet filter 104 is then applied to the output X(k) of the wavelet transform 102. Finally, an inverse wavelet transform 106 is applied to the wavelet filter output, X(k), resulting in a filtered pressure pulse signal, x(n). The filtered pressure pulse signal x(n) is the input pressure pulse signal x(n) with some portion of the noise removed.

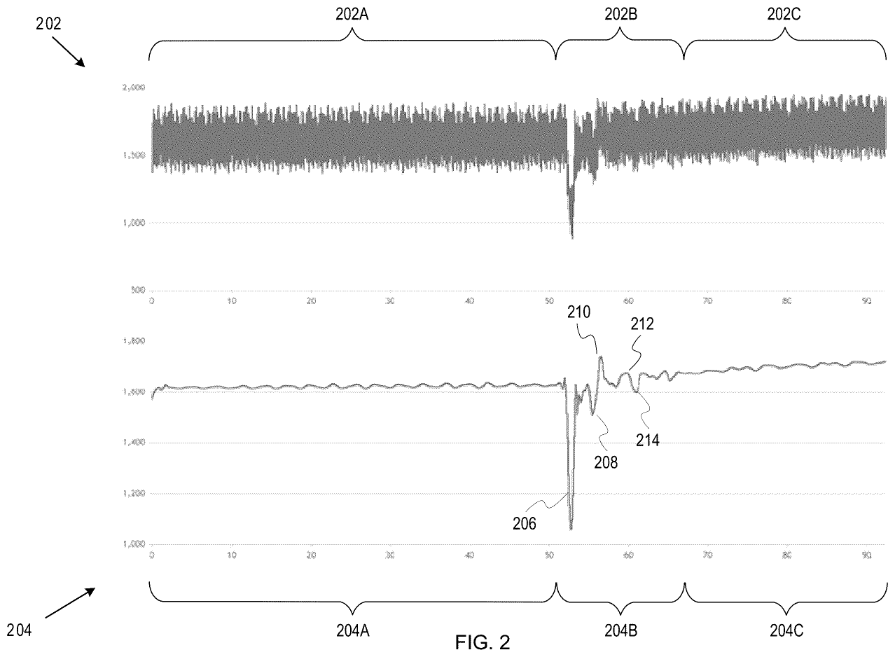

FIG. 2 depicts the result of applying a wavelet filter to a pressure pulse signal, according to some implementations. In particular, FIG. 2 depicts a first graph 202 and a second graph 204. The first graph 202 is an example of a signal recorded from a well system depicting the pressure fluctuations within well system (e.g., pressure fluctuations of drilling or pumping fluids).

Each graph is divided into three segments. The first segment (first segment 202A for the first graph 202 and first segment 204A for the second graph 204) corresponds to the pressure fluctuations prior to the generation of a pressure pulse. The second segment (second segment 202B for the first graph 202 and second segment 204B for the second graph 204) corresponds to the pressure fluctuations when the pressure pulse is generated and shortly thereafter. The third segment (third segment 202C for the first graph 202 and third segment 204C for the second graph 204) corresponds to the pressure fluctuations after the impact of the pressure pulse has subsided.

The first graph 202 illustrates various attributes of the types of pressure fluctuations expected in a well system. In particular, patterns of periodic (or cyclical) pressure fluctuations are visible during the first segment 202A and the third segment 202C. These periodic pressure fluctuations may be caused by various mechanisms during operation of the well system, such as the pumping action, drill bit rotation, etc. Further, the impact of the pressure pulse generation is visible during the second segment 202B, resulting in a large decrease in pressure at approximately T53.

The second graph 204 depicts the results of applying wavelet filtering, as described herein, to the first graph 202. The magnitude of the periodic pressure fluctuations during the first segment 204A and the third segment 204C have been significantly reduced, resulting in a smoother line. Further, comparing the second segment 204B of the second graph 204 with the second segment 202B of the first graph illustrates the different features of the pressure fluctuations due to the pressure pulse. For example, while the first local minimum 206 is visible in the first graph 202 (and, to a lesser extent, local minimum 208 and local maximum 210), the additional features are not readily visible. For example, local maximum 212 and local minimum 214, while clearly visible in the second graph 204, are not visible in the first graph 202.

As noted above, selecting the coefficients to use in the wavelet transform and wavelet filtering can impact the quality of the results. In particular, selecting inappropriate coefficients may fail to remove sufficient noise, leaving the features of the pressure pulse signal indistinguishable from other features, or may result in the removal of too much information, effectively erasing the features of the pressure pulse signal.

Although the first graph 202 and the second graph 204 illustrate various attributes of the types of pressure fluctuations expected in a well system, pipeline and other related systems may exhibit similar attributes.

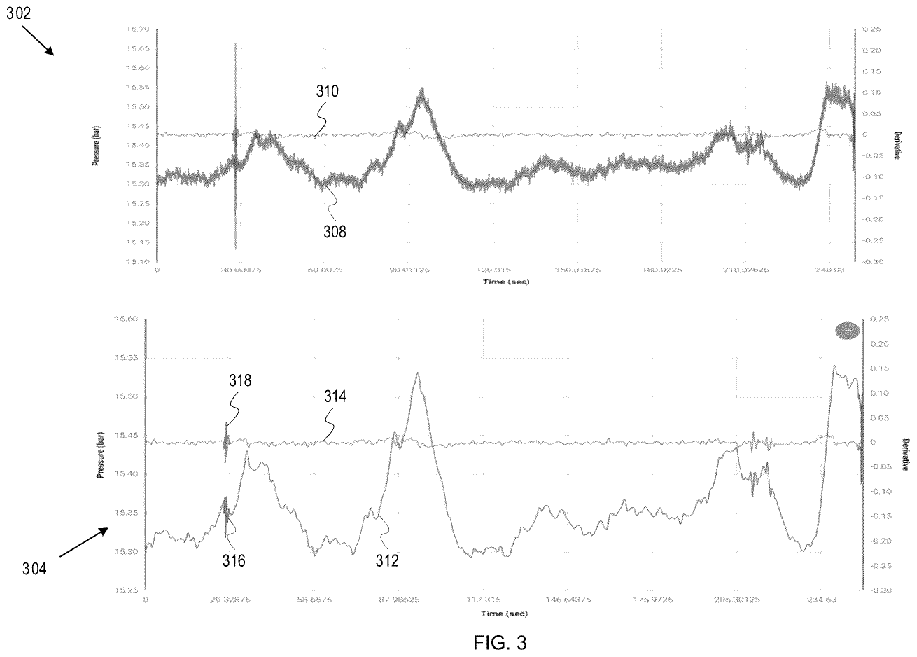

FIG. 3 depicts example charts illustrating the application of wavelet filtering using a first set of coefficients to a first pressure pulse signal, according to some implementations. FIG. 3 depicts a first graph 302 and a second graph 304. The first graph 302 is an example of a pressure pulse signal prior to the application of wavelet filtering. The second graph 304 is an example of a pressure pulse signal after application of wavelet filtering.

The first graph 302 includes the first pressure pulse signal 308 and the first derivative of the first pressure pulse signal 310. The second graph 304 includes the filtered first pressure pulse signal 312 and the first derivative of the filtered first pressure pulse signal 314.

The coefficients for the wavelet transform and wavelet filtering used for the filtering of the first pressure pulse signal 308 have been selected such that the wavelet filtering has removed a substantial portion of the noise from the first pressure pulse signal 308, leaving the pressure pulse features visible in the filtered first pressure pulse signal 312 at point 316 and visible in the first derivative of the of the filtered first pressure pulse signal 314 at point 318.

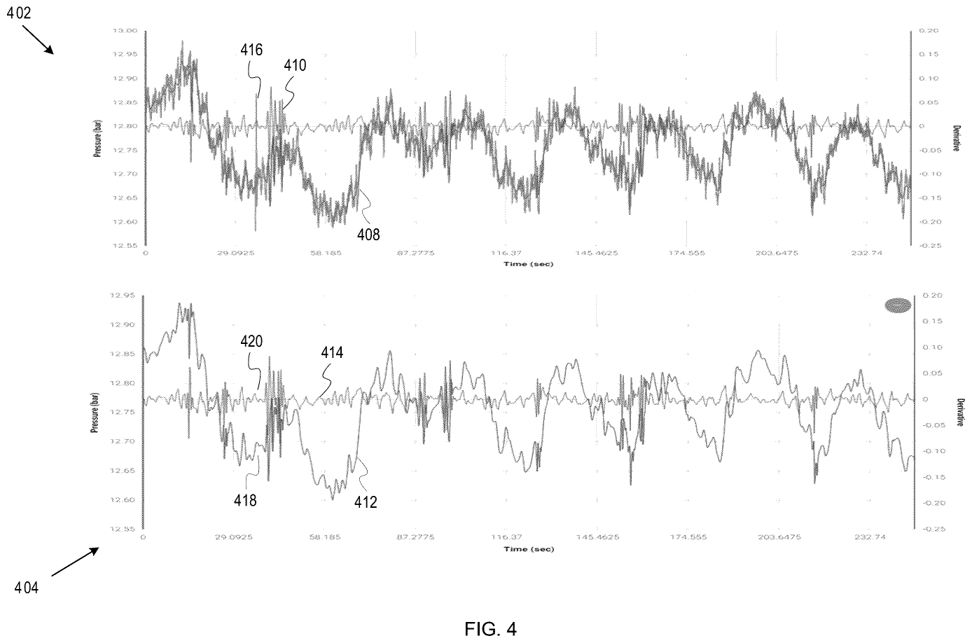

FIG. 4 depicts example charts illustrating the application of wavelet filtering using a second set of coefficients to a second pressure pulse signal, according to some implementations. FIG. 4 depicts a first graph 402 and a second graph 404. The first graph 402 is an example of a pressure pulse signal prior to the application of wavelet filtering. The second graph 304 is an example of a pressure pulse signal after application of wavelet filtering.

The first graph 402 includes the second pressure pulse signal 408 and the first derivative of the second pressure pulse signal 410. The second graph 404 includes the filtered second pressure pulse signal 412 and the first derivative of the filtered second pressure pulse signal 414.

The coefficients for the wavelet transform and wavelet filtering used for the filtering of the second pressure pulse signal 408 have been selected such that the wavelet filtering has removed an insubstantial portion of the noise from the second pressure pulse signal 408, resulting in the pressure pulse feature 416 being indistinguishable from the rest of the filtered second pressure pulse signal 412. In particular, the pressure pulse feature 416 should be visible at point 418 in the filtered second pressure pulse signal 412 and at point 420 in the first derivative of the filtered second pressure pulse signal 414.

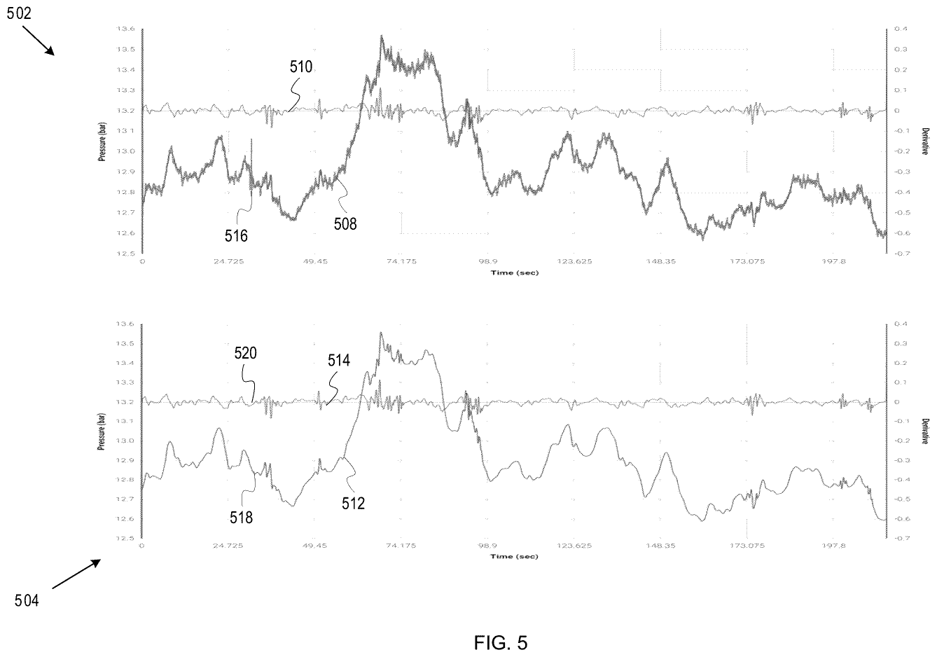

FIG. 5 depicts example charts illustrating the application of wavelet filtering using a third set of coefficients to a third pressure pulse signal, according to some implementations. FIG. 5 depicts a first graph 502 and a second graph 504. The first graph 502 is an example of a pressure pulse signal prior to the application of wavelet filtering. The second graph 504 is an example of a pressure pulse signal after application of wavelet filtering.

The first graph 502 includes the third pressure pulse signal 508 and the first derivative of the third pressure pulse signal 510. The second graph 504 includes the filtered third pressure pulse signal 514 and the first derivative of the filtered third pressure pulse signal 514.

The coefficients for the wavelet transform and wavelet filtering used for the filtering of the third pressure pulse signal 508 have been selected such that the wavelet filtering has removed a substantial portion of the noise from the third pressure pulse signal 508 but was also removed a substantial portion of the information, resulting in the erasure of the pressure pulse feature 516. In particular, the pressure pulse feature 516 should be visible at point 518 in the filtered third pressure pulse signal 512 and at point 520 in the first derivative of the filtered third pressure pulse signal 514.

### Example System

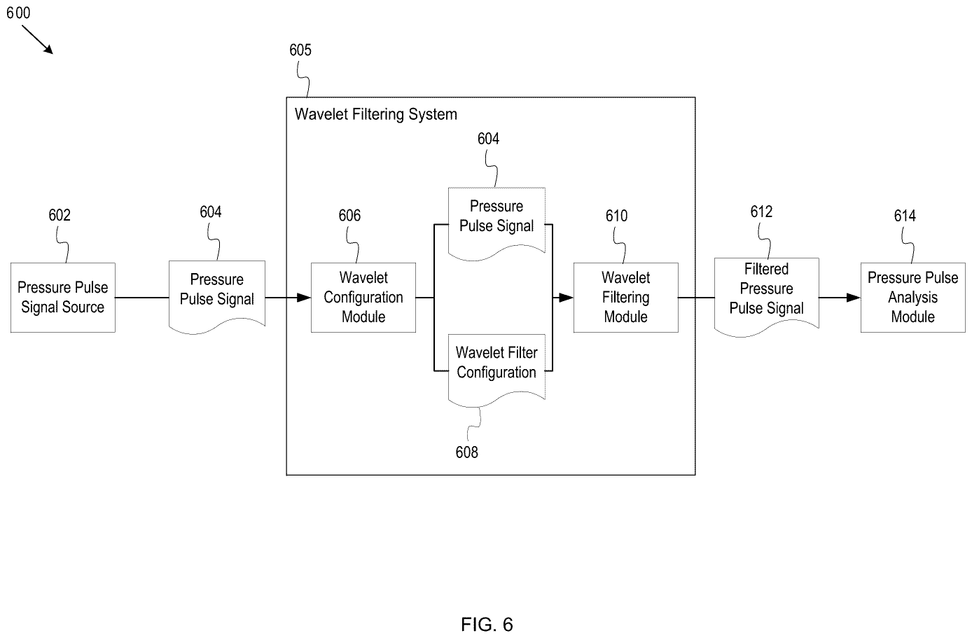

FIG. 6 depicts a system for filtering noise from a pressure pulse signal using a wavelet filter, according to some implementations. FIG. 6 depicts a pressure pulse signal source 602, a pressure pulse signal 604, a wavelet filtering system 605, a filtered pressure pulse signal 612, and a pressure pulse analysis module 614. The wavelet filtering system 605 comprises a wavelet configuration module 606, a wavelet filter configuration 608, and a wavelet filtering module 610.

The wavelet filtering system 605 can comprise one or more computing systems and the components of the wavelet filtering system 605 can be implemented in hardware, software, firmware, or any combination thereof. Some or all of the wavelet filtering system 605 may be cloud-computing based and may be operated manually, automatically, or a combination thereof.

The wavelet configuration may vary depending on the particular implementation of the wavelet filtering system 605, the wavelet filtering module 610, etc. In this example, the wavelet filter configuration 608 comprises an indication of a number of levels and one or more coefficients.

In operation, the pressure pulse signal source 602 generates a pressure pulse signal. The pressure pulse signal source 602 can be anything capable of providing a pressure pulse signal to the wavelet filtering system 605. For example, the pressure pulse signal source 602 may be a transducer located in or otherwise coupled with a well system or may be storage media coupled with the wavelet filtering system.

The pressure pulse signal 604 is received by the wavelet filtering system 605 and then the wavelet configuration module 606.

The wavelet configuration module 606 determines the wavelet filter configuration 608 based, at least in part, on the pressure pulse signal 604. For example, the wavelet configuration module 606 may determine the number of levels and the coefficients. Some implementations of a wavelet filtering system 605 may iteratively identify a suitable wavelet configuration, adjusting a previously generated wavelet configuration module if the resulting filtered pressure pulse signal 612 does not meet certain criteria.

The wavelet filtering module 610 receives the pressure pulse signal 604 and the wavelet filter configuration 608. The wavelet filtering module 610 then performs one or more operations to produce the filtered pressure pulse signal 612. For example, the wavelet filtering module 610 may perform a wavelet transform operation, a wavelet filtering operation, and an inverse wavelet transform operation in the process of generating the filtered pressure pulse signal 612.

As noted above, the wavelet filtering system 605 may use an iterative process to identify a suitable wavelet configuration. In these implementations, the wavelet filtering module 610 may be responsible for determining whether the filtered pressure pulse signal 612 meets the appropriate criteria and triggering the iterative process if the appropriate criteria is not met.

Once the filtered pressure pulse signal 612 is generated (or a filtered pressure pulse signal that meets the appropriate criteria is generated), the filtered pressure pulse signal is sent to the pressure pulse analysis module 614. The filtered pressure pulse signal 612 may be sent to the pressure pulse analysis module 614 directly or indirectly (e.g., after being stored on a storage device or the like).

After receiving the filtered pressure pulse signal 612, the pressure pulse analysis module 614 may analyze the filtered pressure pulse signal 612 to determine one or more characteristics or conditions of the system that generated the pressure pulse signal 604. For example, the pressure pulse analysis module 614 may perform analytical operations to determine based, at least in part, on the filtered pressure pulse signal 612, whether a portion of the system is blocked, whether there is a leak in the system, the distance of an object within the system, etc. Or, it may be integrated with further filtering techniques to improve solution quality.

### Example Operations

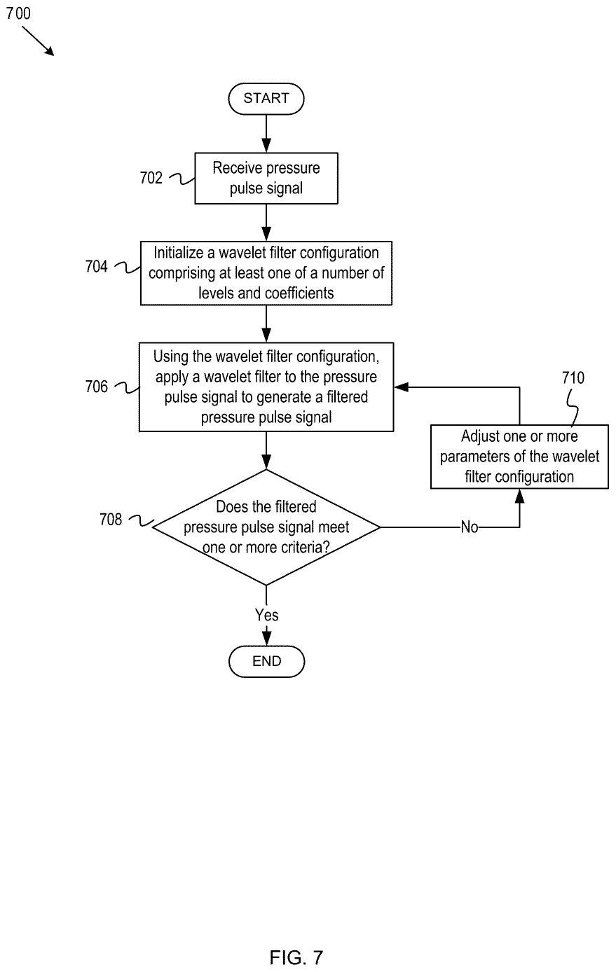

FIG. 7 is a flow diagram depicting operations for determining a wavelet filter configuration, according to some implementations. FIG. 7 includes a flow diagram 700 comprising a set of operations for determining a wavelet filter configuration. The operations depicted in the flow diagram 700 can be performed by hardware, firmware, software, or any combination thereof, including the wavelet filtering system 605 of FIG. 6 or by one or more computing systems as described herein. The operations begin at block 702.

At block 702, a pressure pulse signal is received.

At block 704, a wavelet filter configuration comprising at least one of a number of levels and one or more coefficients is initialized. The initial configuration may be generated manually (e.g., via user input) or may be generated automatically. The initial configuration may be based on various properties of a system associated with the pressure pulse signal, operating conditions of the system associated with the pressure pulse signal, properties of the pressure pulse signal (e.g., sampling rate), etc.

At block 706, a wavelet filter using the wavelet filter configuration is applied to the pressure pulse signal to generate a filtered pressure pulse signal.

At block 708, it is determined whether the filtered pressure pulse signal meets one or more criteria. For example, the criteria may include the amount of noise reduction between the pressure pulse signal and the filtered pressure pulse signal. If it is determined that the filtered pressure pulse does not meet the one or more criteria, control flows to block 710. If it is determined that the filtered pressure pulse does meet the one or more criteria, the process ends.

At block 710, one or more parameters of the wavelet filter configuration are adjusted. For example, the number of levels may be increased or decreased or other inputs for determining the coefficients may be modified. Some of the adjustments may be based on the particular criteria that was not met. For example, if one or more of the criteria represents the amount of noise reduction that occurred between the pressure pulse signal and the filtered pressure pulse signal, parameters may be adjusted to increase or decrease the amount of noise reduction depending on whether too much or too little noise reduction occurred.

After adjusting the one or more parameters of the wavelet filter configuration, control flows back to block 706.

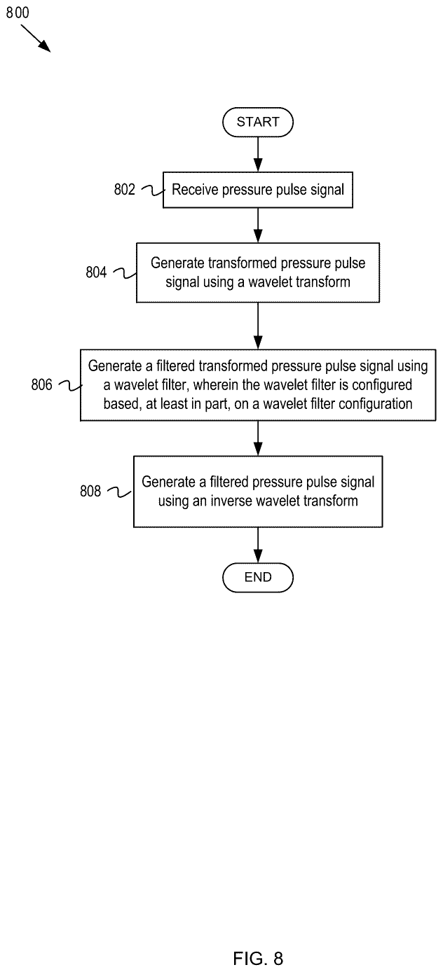

FIG. 8 is a flow diagram depicting operations for filtering a pressure pulse signal using wavelet filtering, according to some implementations. FIG. 8 includes a flow diagram 800 comprising a set of operations for filtering a pressure pulse signal using wavelet filtering. The operations depicted in the flow diagram 800 can be performed by hardware, firmware, software, or any combination thereof, including the wavelet filtering system 605 of FIG. 6 or by one or more computing systems as described herein. The operations begin at block 802.

At block 802, a pressure pulse is received.

At block 804, a transformed pressure pulse signal is generated using a wavelet transform.

At block 806, a filtered and transformed pressure pulse signal is generated using a wavelet filter. The wavelet filter is configured based, at least in part, on a wavelet filter configuration.

At block 808, a filtered pressure pulse signal is generated using an inverse wavelet transform.

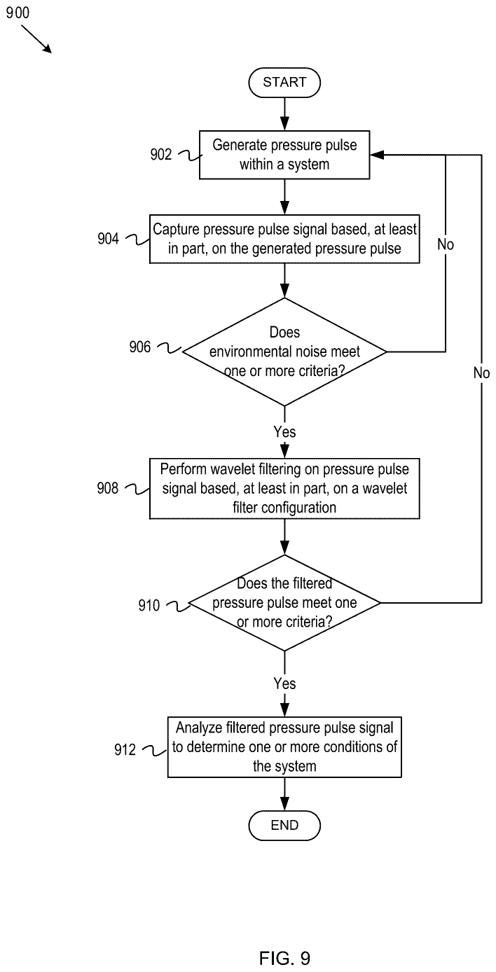

FIG. 9 is a flow diagram depicting operations for determining one or more conditions of a well, pipeline, or similar system using wavelet filtering, according to some implementations. FIG. 9 includes a flow diagram 900 comprising a set of operations for determining a wavelet filter configuration. The operations depicted in the flow diagram 900 can be performed by hardware, firmware, software, or any combination thereof, including the wavelet filtering system 605 of FIG. 6 or by one or more computing systems as described herein. The operations begin at block 902.

At block 902, a pressure pulse is generated within a well, pipeline, or similar system.

At block 904, a pressure pulse signal is captured based, at least in part, on the generated pressure pulse.

At block 906, it is determined whether environmental noise captured in the pressure pulse signal meets one or more criteria. If the environmental noise captured in the pressure pulse signal meets the one or more criteria, control flows to block 908. If the environment noise captured in the pressure pulse signal does not meet the one or more criteria, control flows back to block 902.

At block 908, wavelet filtering on pressure pulse signal is performed based, at least in part, on a wavelet filter configuration.

At block 910, it is determined whether the filtered pressure pulse meets one or more criteria. For example, it may be determined whether the filtered pressure pulse meets noise reduction criteria. If it is determined that the filtered pressure pulse meets the one or more criteria, control flows to block 912. It is determined that the filtered pressure pulse does not meet the one or more criteria, control flows back to block 902.

At block 912, the filtered pressure pulse signal is analyzed to determine one or more conditions of the system. For example, the filtered pressure pulse signal may be analyzed to determine if there is a leak in the system, if a plug is located in the correct place, etc.

Although not depicted in FIG. 9, some implementations may have an additional step in which one or more system operations (e.g., downhole operations) are modified based, at least in part, on the one or more conditions of the system that were determined based on the filtered pressure pulse analysis. For example, if analysis of the pressure pulse signal determines that the location of a plug in a well system is incorrect, downhole operations may be modified to move the plug into the correct location. As another example, if analysis of the pressure pulse signal determines that there is a leak in the system, the composition of the pumping fluid may be modified to attempt to plug the leak.

### Example Well System

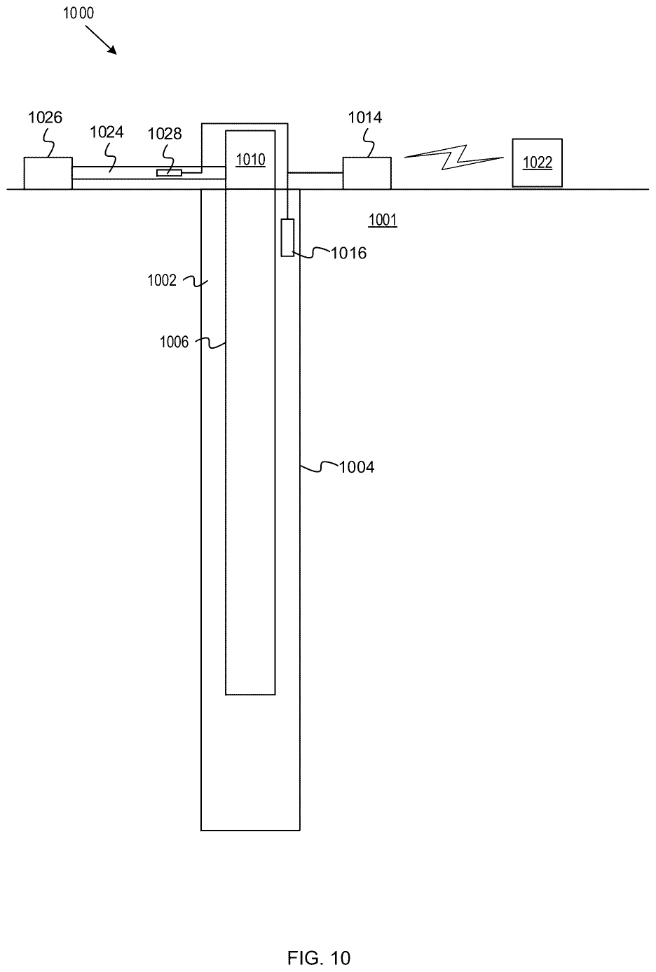

FIG. 10 is a diagrammatic illustration of an example well system, according to some implementations. In particular, FIG. 10 depicts a well system 1000 that includes a wellbore 1002 in a formation 1001. The wellbore 1002 includes a casing 1004 and a tubular string 1006 (the production tubing). The well system 1000 further comprises a wellhead 1010 and a pipeline 1024 extending from the wellhead 1010 to a storage tank 1026.

A first signal generation device 1016 (e.g., transducer) configured to sample the pressure in the wellbore 1002 is located in or otherwise coupled with the well system 100. Similarly, a second signal generation device 1028 (e.g., transducer) configured to sample the pressure in the pipeline 1024 is located in or otherwise coupled with the well system 1000. The signal generation devices 1016 and 1028 may be coupled with a computing system 1014 that is configured to record the generated signal. The computing system 1014 may then transmit the generated signal to a wavelet filtering system 1022.

Implementations may differ from this example. For example, the signal generation device 1016 may directly provide the generated signal to the wavelet filtering system 1022 or the computing system 1014 may transmit the generated signal via a wired connection.

When the wavelet filtering system 1022 receives a signal generated by the signal generation device 1016, the wavelet filtering system 1022 may perform one or more of the operations for filtering the signal as described herein.

Although FIG. 10 uses a well system as an example, the operations and configurations described herein can be adapted to be compatible with transport systems (e.g., pipeline systems) and other types of systems. For example, although the pipeline 1024 is depicted as extending between the wellhead 1010 and a storage tank 1026, the pipeline 1024 may be independent from a well system and may extend between components other than those depicts and may also pass through various components and devices. Further, the pipeline 1024 may consist of multiple pipelines coupled together to form a pipeline system.

### Example Computing Systems

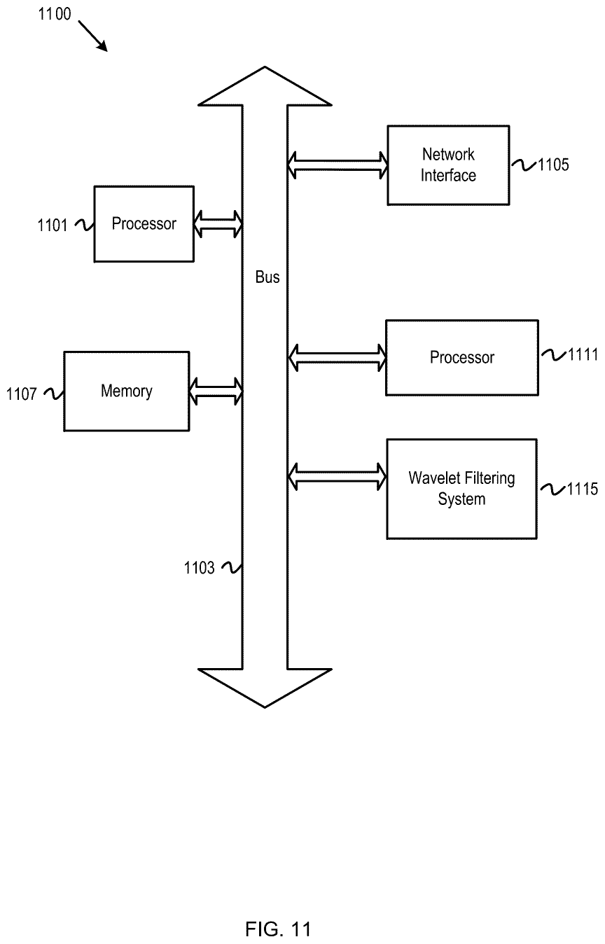

FIG. 11 is a block diagram depicting an example computing system, according to some implementations. FIG. 11 depicts a computing system 1100 for filtering pressure pulse signals using a wavelet filter. The computing system 1100 includes a processor 1101 (possibly including multiple processors, multiple cores, multiple nodes, and/or implementing multi-threading, etc.). The computing system 1100 also includes a wavelet filtering system 1115. The wavelet filtering system 1115 may perform the operations described herein. For example, the wavelet filtering system 1115 may receive a pressure pulse signal, determine a wavelet filter configuration for the pressure pulse signal, apply a wavelet filter to the pressure pulse signal to generate a filtered pressure pulse signature, and analyze the filtered pressure pulse signal to determine one or more system conditions. Any one of the previously described functionalities may be partially (or entirely) implemented in hardware and/or on the wavelet filtering system 1115. For example, the functionality may be implemented with an application specific integrated circuit, in logic implemented in the wavelet filtering system 1115, in a co-processor on a peripheral device or card, etc. Further, realizations may include fewer or additional components not illustrated in FIG. 11 (e.g., video cards, audio cards, additional network interfaces, peripheral devices, etc.). The processor 1101 and the network interface 1105 are coupled to the bus 1103. Although illustrated as being coupled to the bus 1103, the memory 1107 may be coupled to the processor 1101. The computing system 1100 includes memory 1107. The memory 1107 may be system memory or any one or more possible realizations of machine-readable media. The computing system 1100 can communicate via transmissions to and/or from remote devices via the network interface 1105 in accordance with a network protocol corresponding to the type of network interface, whether wired or wireless and depending upon the carrying medium. In addition, a communication or transmission can involve other layers of a communication protocol and or communication protocol suites (e.g., transmission control protocol, Internet Protocol, user datagram protocol, virtual private network protocols, etc.).

While the aspects of the disclosure are described with reference to various implementations and exploitations, it will be understood that these aspects are illustrative and that the scope of the claims is not limited to them. In general, techniques for filtering pressure pulses using wavelet filters as described herein may be implemented with facilities consistent with any hardware system or hardware systems. Many variations, modifications, additions, and improvements are possible.

Plural instances may be provided for components, operations or structures described herein as a single instance. Further, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

The flowcharts are provided to aid in understanding the illustrations and are not to be used to limit the scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

As used herein, the term “or” is inclusive unless otherwise explicitly noted. Thus, the phrase “at least one of A, B, or C” is satisfied by any element from the set {A, B, C} or any combination thereof, including multiples of any element.

### Example Implementations

Implementation 1: A method for filtering a pressure pulse signal, the method comprising receiving the pressure pulse signal; determining a first wavelet filtering configuration, wherein the first wavelet filtering configuration comprises at least one of a number of levels or one or more coefficients; and generating a first filtered pressure pulse signal based, at least in part, on the pressure pulse signal and a wavelet filter, wherein the wavelet filter is configured based on the first wavelet filtering configuration.

Implementation 2: The method according to Implementation 1, further comprising determining one or more system conditions based on the first filtered pressure pulse signal, wherein the one or more system conditions are associated with at least one of a well system or a pipeline system.

Implementation 3: The method according to Implementation 2, wherein at least one of a system operation or a system attribute in a wellbore or pipeline is modified based on the one or more system conditions.

Implementation 4: The method according to any of the preceding implementations, further comprising directing an operation to modify at least one of a system operation or a system attribute in a system based on the one or more system conditions.

Implementation 5: The method according to any of the preceding implementations, further comprising modifying at least one of a system operation or a system attribute in a wellbore or pipeline based on the one or more system conditions.

Implementation 6: The method according to any of the preceding implementations, further comprising determining that the first filtered pressure pulse signal does not meet one or more first criteria; in response to determining that the first filtered pressure pulse signal does not meet the one or more first criteria, generating a second wavelet filtering configuration based on the first wavelet filtering configuration; and generating a second filtered pressure pulse signal based on the pressure pulse signal and the wavelet filter, wherein the wavelet filter is configured based on the second wavelet filtering configuration.

Implementation 7: The method according to Implementation 6, wherein the one or more first criteria comprises one or more second criteria specifying a minimum amount of noise reduction or a maximum amount of noise reduction.

Implementation 8: The method according to any of the preceding implementations, further comprising applying one or more additional signal processing techniques to the first filtered pressure pulse signal.

Implementation 9: The method according to any of the preceding implementations, wherein the one or more additional signal processing techniques comprise at least one of a band pass filter, a Butterworth filter, or a Fourier filter.

Implementation 10: A system comprising one or more computing systems, the computing systems comprising one or more processors and one or more non-transitory computer-readable mediums including instructions which, when executed by the one or more processors, cause the one or more processors to filter a pressure pulse signal using a wavelet filter, the instructions including instructions to receive the pressure pulse signal; instructions to determine a first wavelet filtering configuration, wherein the first wavelet filtering configuration comprises at least one of a number of levels or one or more coefficients; and instructions to generate a first filtered pressure pulse signal based, at least in part, on the pressure pulse signal and the wavelet filter, wherein the wavelet filter is configured based on the first wavelet filtering configuration.

Implementation 11: The system according to Implementation 10, wherein the instructions further comprise instructions to determine one or more system conditions based on the first filtered pressure pulse signal, wherein the one or more system conditions are associated with at least one of a well system or a pipeline system.

Implementation 12: The system according to Implementation 11, wherein at least one of a system operation or a system attribute in a wellbore or pipeline is modified based on the one or more system conditions.

Implementation 13: The system according to any of the preceding implementations, wherein the instructions further comprise instructions to direct an operation to modify at least one of a system operation or a system attribute in a wellbore or pipeline based on the one or more system conditions.

Implementation 14: The system according to any of the preceding implementations, wherein the instructions further comprise instructions to modify at least one of a system operation or a system attribute in a wellbore or pipeline based on the one or more system conditions.

Implementation 15: The system according to any of the preceding implementations, wherein the instructions further comprise instructions to determine that the first filtered pressure pulse signal does not meet one or more first criteria; in response to a determination that the first filtered pressure pulse signal does not meet the one or more first criteria, generate a second wavelet filtering configuration based on the first wavelet filtering configuration; and generate a second filtered pressure pulse signal based on the pressure pulse signal and the wavelet filter, wherein the wavelet filter is configured based on the second wavelet filtering configuration.

Implementation 16: The system according to Implementation 15, wherein the one or more first criteria comprises one or more second criteria specifying a minimum amount of noise reduction or a maximum amount of noise reduction.

Implementation 17: One or more non-transitory computer-readable mediums including instructions which, when executed by a processor, cause the processor to execute one or more operations for filtering a pressure pulse signal, the instructions comprising instructions to receive the pressure pulse signal; instructions to determine a first wavelet filtering configuration, wherein the first wavelet filtering configuration comprises at least one of a number of levels or one or more coefficients, and instructions to generate a first filtered pressure pulse signal based, at least in part, on the pressure pulse signal and a wavelet filter, wherein the wavelet filter is configured based on the first wavelet filtering configuration.

Implementation 18: The one or more non-transitory computer-readable mediums according to Implementation 17, wherein the instructions further comprise instructions to determine one or more system conditions based on the first filtered pressure pulse signal.

Implementation 19: The one or more non-transitory computer-readable mediums according to Implementation 18, wherein at least one of a system operation or a system attribute in a wellbore or pipeline is modified based on the one or more system conditions.

Implementation 20: The one or more non-transitory computer-readable mediums according to any of the preceding implementations, wherein the instructions further comprise instructions to direct an operation to modify at least one of a system operation or a system attribute in a system based on the one or more system conditions.

Implementation 21: The one or more non-transitory computer-readable mediums according to any of the preceding implementations, wherein the instructions further comprise instructions to modify at least one of a system operation or a system attribute in a wellbore or pipeline based on the one or more system conditions.

Implementation 22: The one or more non-transitory computer-readable mediums according to any of the preceding implementations, wherein the instructions further comprise instructions to determine that the first filtered pressure pulse signal does not meet one or more criteria; in response to a determination that the first filtered pressure pulse signal does not meet the one or more criteria, generate a second wavelet filtering configuration based on the first wavelet filtering configuration; and generate a second filtered pressure pulse signal based on the pressure pulse signal and the wavelet filter, wherein the wavelet filter is configured based on the second wavelet filtering configuration.

1. A method for filtering a pressure pulse signal, the method comprising:
receiving the pressure pulse signal;
determining a first wavelet filtering configuration, wherein the first wavelet filtering configuration comprises at least one of a number of levels or one or more coefficients; and
generating a first filtered pressure pulse signal based, at least in part, on the pressure pulse signal and a wavelet filter, wherein the wavelet filter is configured based on the first wavelet filtering configuration.

2. The method of claim 1, further comprising determining one or more system conditions based on the first filtered pressure pulse signal, wherein the one or more system conditions are associated with at least one of a well system or a pipeline system.

3. The method of claim 2, wherein at least one of a system operation or a system attribute in a wellbore or pipeline is modified based on the one or more system conditions.

4. The method of claim 2, further comprising directing an operation to modify at least one of a system operation or a system attribute in a system based on the one or more system conditions.

5. The method of claim 2, further comprising modifying at least one of a system operation or a system attribute in a wellbore or pipeline based on the one or more system conditions.

6. The method of claim 1, further comprising:
determining that the first filtered pressure pulse signal does not meet one or more first criteria;
in response to determining that the first filtered pressure pulse signal does not meet the one or more first criteria, generating a second wavelet filtering configuration based on the first wavelet filtering configuration; and
generating a second filtered pressure pulse signal based on the pressure pulse signal and the wavelet filter, wherein the wavelet filter is configured based on the second wavelet filtering configuration.

7. The method of claim 6, wherein the one or more first criteria comprises one or more second criteria specifying a minimum amount of noise reduction or a maximum amount of noise reduction.

8. The method of claim 1, further comprising applying one or more additional signal processing techniques to the first filtered pressure pulse signal.

9. The method of claim 8, wherein the one or more additional signal processing techniques comprise at least one of a band pass filter, a Butterworth filter, or a Fourier filter.

10. A system comprising:
one or more computing systems comprising:
one or more processors; and
one or more non-transitory computer-readable mediums including instructions which, when executed by the one or more processors, cause the one or more processors to filter a pressure pulse signal using a wavelet filter, the instructions including:
instructions to receive the pressure pulse signal;
instructions to determine a first wavelet filtering configuration, wherein the first wavelet filtering configuration comprises at least one of a number of levels or one or more coefficients; and
instructions to generate a first filtered pressure pulse signal based, at least in part, on the pressure pulse signal and the wavelet filter, wherein the wavelet filter is configured based on the first wavelet filtering configuration.

11. The system of claim 10, wherein the instructions further comprise instructions to determine one or more system conditions based on the first filtered pressure pulse signal, wherein the one or more system conditions are associated with at least one of a well system or a pipeline system.

12. The system of claim 11, wherein at least one of a system operation or a system attribute in a wellbore or pipeline is modified based on the one or more system conditions.

13. The system of claim 11, wherein the instructions further comprise instructions to modify at least one of a system operation or a system attribute in a wellbore or pipeline based on the one or more system conditions.

14. The system of claim 10, wherein the instructions further comprise instructions to:
determine that the first filtered pressure pulse signal does not meet one or more first criteria;
in response to a determination that the first filtered pressure pulse signal does not meet the one or more first criteria, generate a second wavelet filtering configuration based on the first wavelet filtering configuration; and
generate a second filtered pressure pulse signal based on the pressure pulse signal and the wavelet filter, wherein the wavelet filter is configured based on the second wavelet filtering configuration.

15. The system of claim 14, wherein the one or more first criteria comprises one or more second criteria specifying a minimum amount of noise reduction or a maximum amount of noise reduction.

16. One or more non-transitory computer-readable mediums including instructions which, when executed by a processor, cause the processor to execute one or more operations for filtering a pressure pulse signal, the instructions comprising:
instructions to receive the pressure pulse signal;
instructions to determine a first wavelet filtering configuration, wherein the first wavelet filtering configuration comprises at least one of a number of levels or one or more coefficients; and
instructions to generate a first filtered pressure pulse signal based, at least in part, on the pressure pulse signal and a wavelet filter, wherein the wavelet filter is configured based on the first wavelet filtering configuration.

17. The one or more non-transitory computer-readable mediums of claim 16, wherein the instructions further comprise instructions to determine one or more system conditions based on the first filtered pressure pulse signal.

18. The one or more non-transitory computer-readable mediums of claim 17, wherein at least one of a system operation or a system attribute in a wellbore or pipeline is modified based on the one or more system conditions.

19. The one or more non-transitory computer-readable mediums of claim 17, wherein the instructions further comprise instructions to modify at least one of a system operation or a system attribute in a wellbore or pipeline based on the one or more system conditions.

20. The one or more non-transitory computer-readable mediums of claim 16, wherein the instructions further comprise instructions to:
determine that the first filtered pressure pulse signal does not meet one or more criteria;
in response to a determination that the first filtered pressure pulse signal does not meet the one or more criteria, generate a second wavelet filtering configuration based on the first wavelet filtering configuration; and
generate a second filtered pressure pulse signal based on the pressure pulse signal and the wavelet filter, wherein the wavelet filter is configured based on the second wavelet filtering configuration.
